(19) United States
(12) Patent Application Publication
(10) Pub. No.: US 2006/0259923 A1
(43) Pub. Date: Nov. 16, 2006

(54) Interactive multimedia interface display

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/127,247

(22) Filed: May 12, 2005

(51) Int. Cl. H04N 7/173; G06F 13/00; H04N 7/16; H04N 5/445; G06F 3/00

(52) U.S. Cl. 725/24; 725/37; 725/135

(57) ABSTRACT

An interactive multimedia interface and display for providing a wide variety of multimedia content and services to a plurality of users utilizing various platforms. Users or a group of users can participate in interactive multimedia sessions and communicate by text messaging, audio, or video signals in real time. Numerous interactive tools such as application sharing, synchronized internet browsing allowing users to browse the network together, file distribution and sharing, voting and polling, session recording, shared whiteboard, and chat room are provided. Advertising and purchasing information windows allow products to be advertised and purchased. The layout, size, and interactive tools offered can be flexible adapted to requirements.

### BACKGROUND OF THE INVENTION

1. Field of the Invention

The present invention relates to multimedia. More specifically, the present invention discloses an interactive multimedia interface and display which allows a flexible way of providing a plurality of multimedia content and interactive activities.

2. Description of the Prior Art

Traditional television broadcasting is achieved by transmitting the television signal via satellite or cable to a number of viewers. The television content is pre-scheduled and pre-recorded. While this method is suitable for certain types of content, the inflexible nature of this system is a disadvantage for modern content delivery. Additionally, since the content is pre-recorded, users must be present during broadcast which can be inconvenient.

Furthermore, viewers are limited to content chosen by the broadcaster. In traditional broadcasting users simply view the content, which is a passive experience without interaction. This lack of interaction quickly leads to boredom and lowered viewer satisfaction.

Moreover, the conventional method does not provide a suitable interface for allowing various types of displays, layouts, or adapting size of the display components.

Therefore, there is need for an interactive multimedia interface and display which provides a plurality of multimedia content and interactive activities in a flexible and adaptable manner.

### SUMMARY OF THE INVENTION

To achieve these and other advantages and in order to overcome the disadvantages of the conventional method in accordance with the purpose of the invention as embodied and broadly described herein, the present invention provides a flexible and changeable interactive multimedia interface and display which allows users to interact with a plurality of multimedia content and activities and with other members.

The present invention also provides an interactive multimedia interface that provides a flexible and adaptable interface for providing a wide variety of multimedia content and services to a plurality of users utilizing various platforms. For example, users can utilize the Internet, satellite television, cable television, television equipped with set top boxes, telecom network, wireless, cellular phone, local area network, or other electronic equipment connected to other types of networks.

Additionally, the present invention allows users to not only enjoy the multimedia content, but also interact with the multimedia content, thereby increasing the participant's level of enjoyment and satisfaction. As a result users are more likely to participate more frequently and for longer periods of time.

The present invention supports streaming of multiple video and audio signals simultaneously on a single channel. For example, 8 video signal and 8 audio signals can be provided on a single channel. As a result, a single display or window can allow users to conveniently interact with these multiple multimedia signals. Since the present invention provides real-time or near real-time streaming, content providers or producers can utilize interactive applications. For example, when a content producer provides multimedia content, users can interact with the multimedia content and with other users in real-time.

Additionally, the present invention provides a plurality of channels for users to select from. For example, channels with specific content or themes such as movies, education, meetings, conferences, and concerts can be provided to users. Channels can be grouped by theme or area of interest. Users or a group of users can participate in interactive multimedia sessions and communicate by text messaging, audio, or video signals in real time or near real time. Furthermore, numerous interactions such as application sharing, synchronized internet browsing, file distribution and sharing, voting and polling, session recording, shared whiteboard, and chat room are provided.

The interactive multimedia interface and display is flexible, allowing content providers to offer various interactive tools, applications, and layouts for members.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating an infrastructure of an interactive multimedia system utilized by the interactive multimedia interface and display according to an embodiment of the present invention;

FIG. 2 is a diagram illustrating an interactive multimedia interface and display according to an embodiment of the present invention;

FIGS. 3A-3F are diagrams illustrating an interactive multimedia interface and display according to an embodiment of the present invention; and

FIGS. 4-8 are diagrams illustrating an interactive multimedia interface and display according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

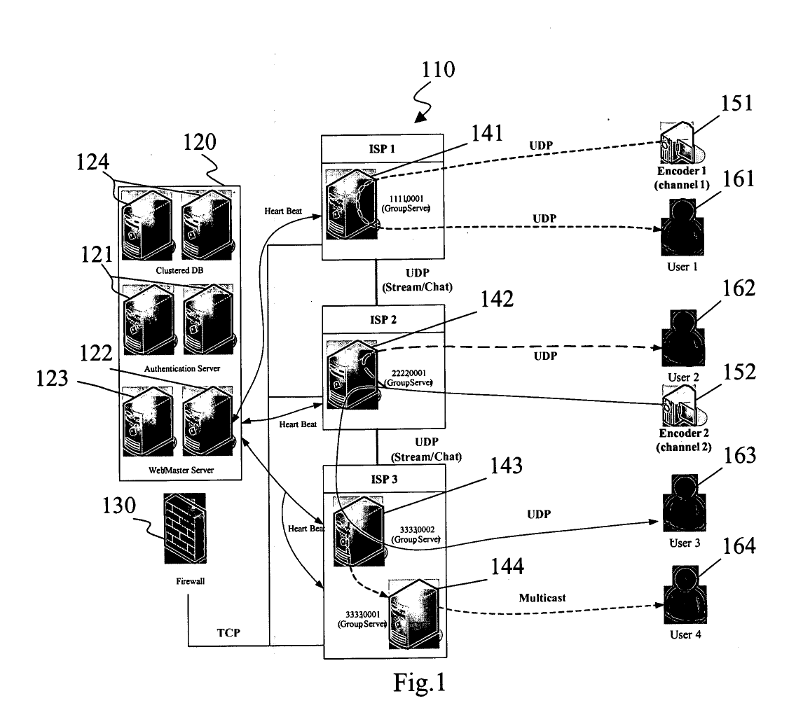

Refer to FIG. 1, which is a diagram illustrating the infrastructure of an interactive multimedia system utilized by the interactive multimedia interface and display according to an embodiment of the present invention.

The infrastructure of the interactive multimedia system 110 basically comprises a core server 120 or core servers, a plurality of streaming server 141, 142, 143, 144, and at least one encoder 151, 152. Multimedia content is streamed from the encoder 151 to a user 161 via a streaming server 241.

The core servers 120 comprise an authentication server 121, a master server 122, a web server 123, and a database 124. The authentication server 121 is for checking authenticity of users. Users must pass the authenticity check before they can connect to a streaming server. The master server 122 is for redirecting users to a specific streaming server based on the policy defined in the master server 122. The policy determines which server streams the multimedia content to users. The policy can consider an IP range, user information, user account, company name, channel, etc. For example, the policy can be set so that a user's IP indicates the user's location, and an appropriate streaming server located near the user's location can be selected.

The web server 123 provides program information, for example like television program information, to assist users in selecting a channel or program. The program information can list program title, producer, synopsis, time, date, popularity, or other information.

The database 124 stores a variety of data such as user information, account information, policies, web information, etc.

The core server 120 can comprise a single server or multiple servers. For example, the authentication server 121, master server 122, web server 123, and database 124 can be realized in a single server. Alternatively, each can be a separate server or a combination of servers.

A firewall 130 separates the core servers 120 and the streaming servers 141, 142, 143, 144. This increases the level of protection for the cores servers 120 and reduces the likelihood of attack by hackers.

The streaming servers are a plurality of servers 141, 142, 143, 144 arranged to stream the multimedia content to and from users 161, 162, 163, 164. By adding more streaming servers, the system can be easily scaled to meet the needs of the number of concurrent users. In this way, the load is balanced between the servers and due to the plurality of streaming servers, the servers have high availability.

In order to determine which streaming servers 141, 142, 143, 144 are available or on-line, the master server 122 periodically sends heart beat signals to each streaming server 141, 142, 143, 144. The heart beat signals are, for example, TCP packets. This allows the master server 122 to maintain a list of active servers. Therefore, if a streaming server is down or brought off line for maintenance, the master server 122 will redirect users to other streaming servers based on the defined policy and list of active servers. Additionally, the channel or channels can be streamed via multicast protocol in order to save bandwidth.

The encoder or encoders 151, 152 encode the multimedia content. They also make real time streaming possible and provide various bit rates and resolutions. According to the capabilities or environment of the network, channels can be encoded as low as 56 Kbps for dial-up links or up to broadband speed, for example 1.5 Mbps or higher, to provide better quality. Similarly, the resolution can be selected. For example, the resolution can be set to 160×120, 176×144, 320×240, 352×288, 640×480, or higher. Additionally, the frame rate can be adjusted according to the available bandwidth with a higher frame rate requiring more bandwidth. The frame rate can be set to, for example, as low as 1 frame per second or as high as 30 frames per second. Furthermore, the encoders 251, 252 utilize an optimized compression codec that allows real-time or near real-time streaming without the need for buffering. This allows users or broadcasters to interact with the streaming multimedia content in real-time or near real-time.

Transmission control protocol (TCP) is used to connect the core servers 120 and the streaming servers 141, 142, 143, 144. TCP guarantees delivery of data and ensures that packets are delivered in the same order in which they were sent.

User datagram protocol (UDP) is used to provide a direct way to send and receive datagrams over the IP network between the encoders 151, 152, streaming servers 141, 142, 143, 144, and users.

Multicasting can be utilized to permit sending content to a select group or number of users. For example, streaming server 143 can comprise several servers 143 144 in order to multicast to users 163 and 164.

As an example of application of the intelligent interactive multimedia system, the following scenario is provided.

A multimedia producer prepares multimedia content. The multimedia content can be pre-recorded or can be live. A multimedia provider creates or assembles the infrastructure required to distribute the multimedia content. The multimedia producer and the multimedia provider can be the same entity or different entities. The multimedia provider also prepares programming information regarding the multimedia content to assist users in making program or channel selection.

Once the system is established, users can register or sign up for the service. Their user and account information is stored in a database. After the user connects with the multimedia provider and enters their access information, their authenticity is verified. Then the user is able to access the programming information or guide in order to select a channel. When the user has selected the desired channel, the appropriate streaming server is selected and the multimedia content begins streaming to the user.

Since the multimedia content is streamed in real-time or near real-time, the user is able to interact with the content. There are numerous ways in which the user can perform this interaction. For example, if the user is connected via the Internet, the user can simply type text into a field in the chat portion of the interface. Depending upon the channel, provider, policy, or producer, the text can automatically show up or can be selectively chosen to show up on the multi-section display. This allows other users to see the sender's comments. In this way, all users of the channel can communicate between each other or with the producer in real-time. Additionally, this allows the content producer to adapt their programming according to user's feedback or discussion. For example, if the multimedia content is a movie, users can may comments or discuss aspects of the movie as it is showing. In another example, if the content is an educational program such as a class on a particular subject, the users can participate in the lecture as students by asking or answering questions.

In addition to text, the system also allows users to provide video and audio signals with the addition of a microphone and web camera. In this way, the users can act as partial content producers. As in the educational program example above, video of the instructor would appear in one portion of the display and video of individual students can be displayed in other portions of the display. The multi-section display could simultaneously comprise, for example, video from a plurality of individual students as well video of the instructor. Similarly, audio from different users can be heard in addition to the instructors. This allows the virtual environment of the channel to be as close to an in-person experience as possible.

Users can also achieve similar results by using a television equipped with a set top box. Alternatively, users can utilize a cellular telephone, for example a 3G handset, to interact. Depending upon the user's equipment the interaction can comprise short message service (SMS) messages, multimedia message service (MMS) messages, still photographs, video, and audio. Furthermore, users can enjoy the audio portion of the multimedia content and interact audibly with the content by using a traditional telephone.

The intelligent interactive multimedia supports simultaneous streaming of multiple video and audio signals on a single channel. Real-time or near real-time streaming across the network is provided due to the enhanced compression technology. This allows content producers or content providers to provide interactive applications and content to users.

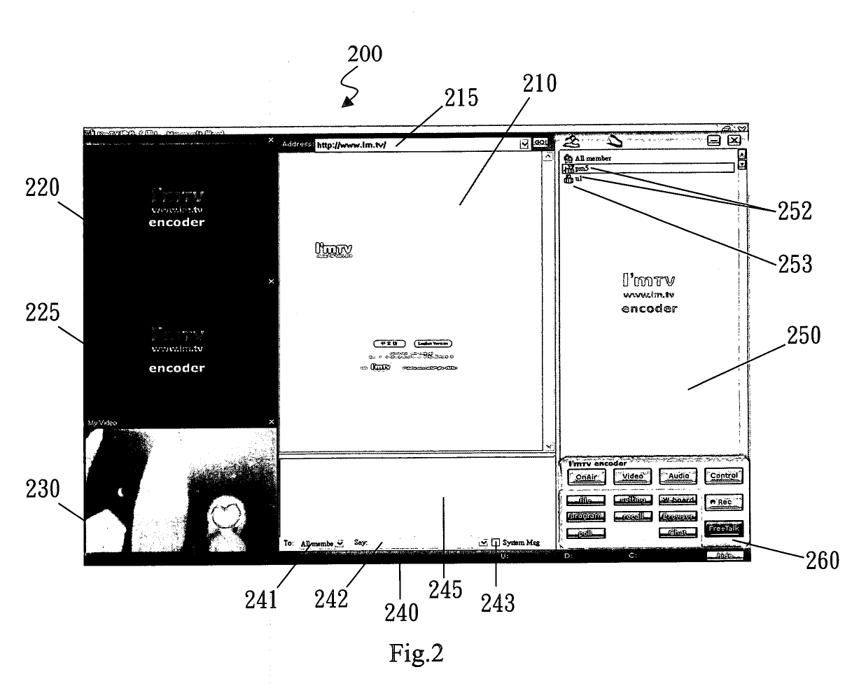

Refer to FIG. 2, which is an interactive multimedia interface and display according to an embodiment of the present invention.

As shown in FIG. 2, the interface incorporates a variety of interactive multimedia activities and options. In this embodiment the interface 200 comprises an Internet browser window 210 with address bar 215, two multimedia windows 220, 225, a user multimedia window 230, a messaging window 240, a member list window 250, and a control section 260.

The Internet browser window 210 allows users to access and view Internet content and web pages. The address can be input into the address bar 215 or hyperlinks can be used inside web pages.

The multimedia windows 220 225 provide a display for viewing multimedia content provided by a host, content producer, or other user. The user multimedia window 230 displays the user's multimedia content to be uploaded or their webcam video.

The message window 240 allows users to send text messages, mms messages, sms messages, or other types of messages. The intended recipient of the message can be selected by the To box 241. The recipient can be all users or members or to a particular member or members. The text is input via the text input box 242. System messages can be sent by selecting the system message box 243.

The member list window 250 displays all users and their current activity. The member's names 252 are displayed as well as a current status icon 253 indicating their current status. For example, if a member is away, on-line, off-line, busy, etc. the current status icon 253 will represent this accordingly.

The control section 260 provides a variety of control options for interfacing with various interactive or program commands. By selecting a button, an appropriate function or command will execute.

The size, orientation, position, and layout of the interface can be pre-set by the multimedia provider, or adjustable by the individual member. For example, a member can select to only have a single multimedia window, or close their personal window and display more multimedia windows.

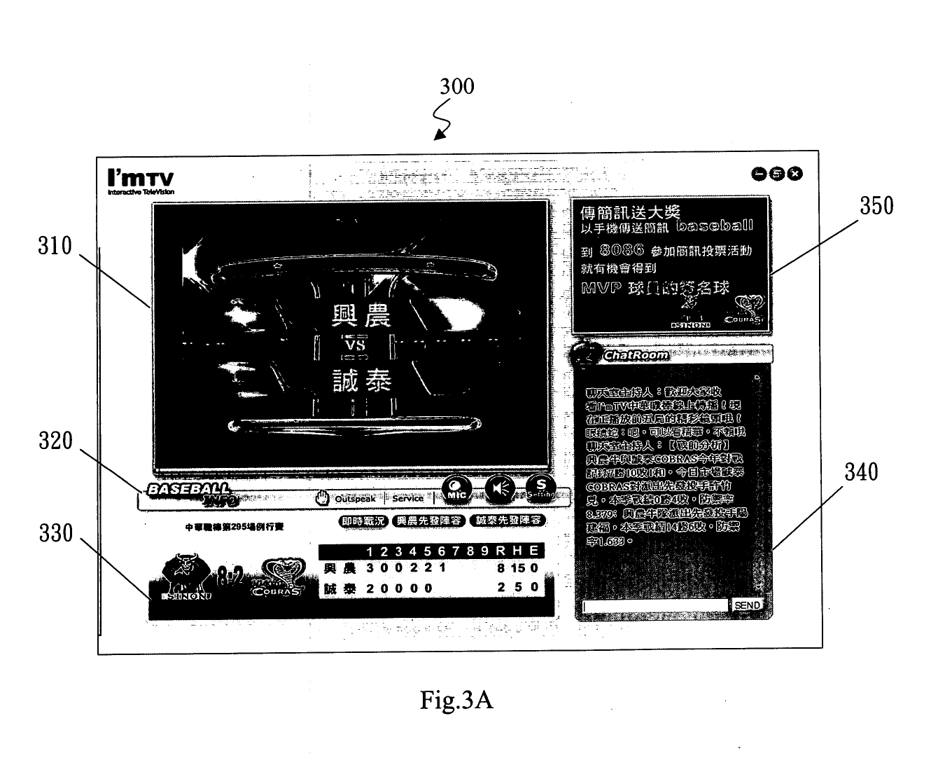

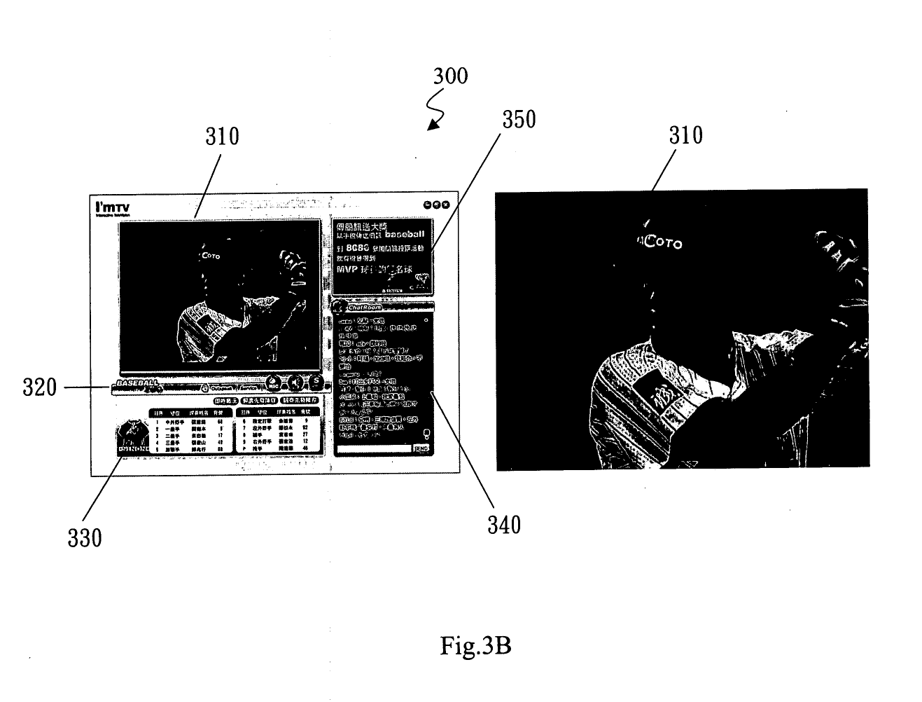

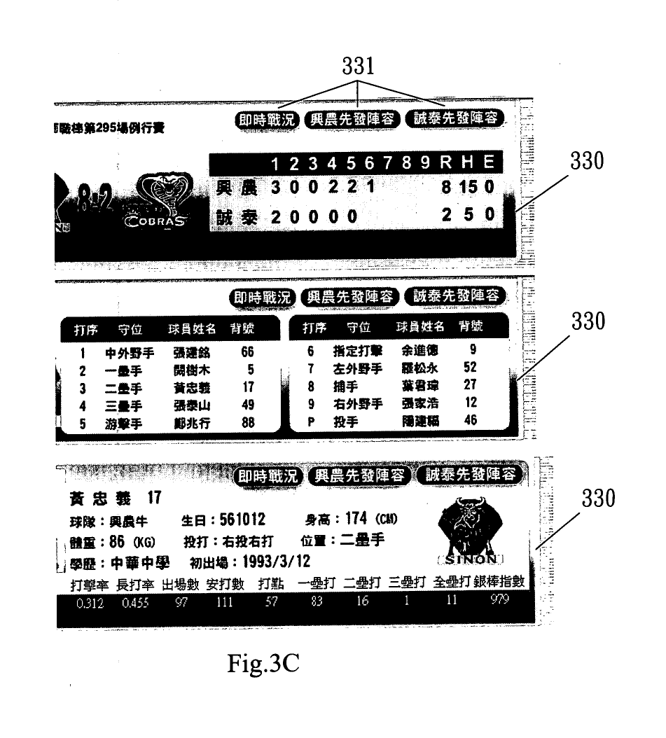

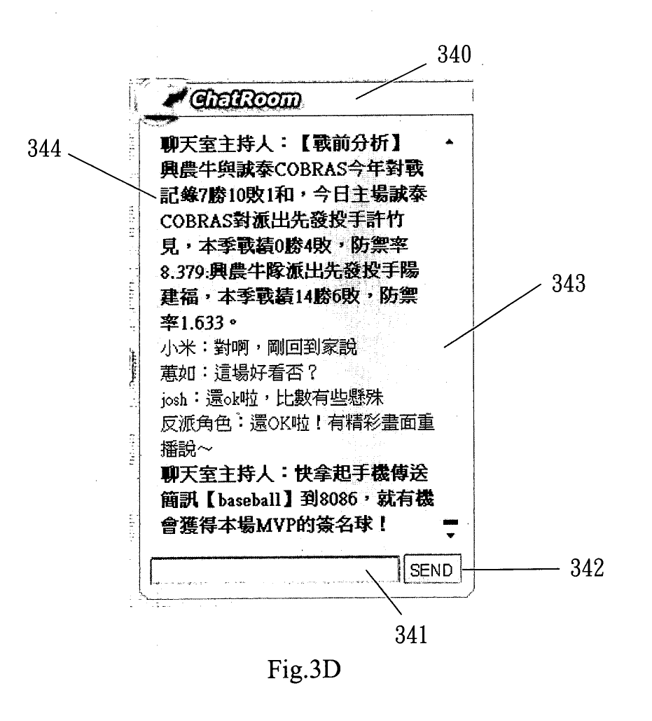

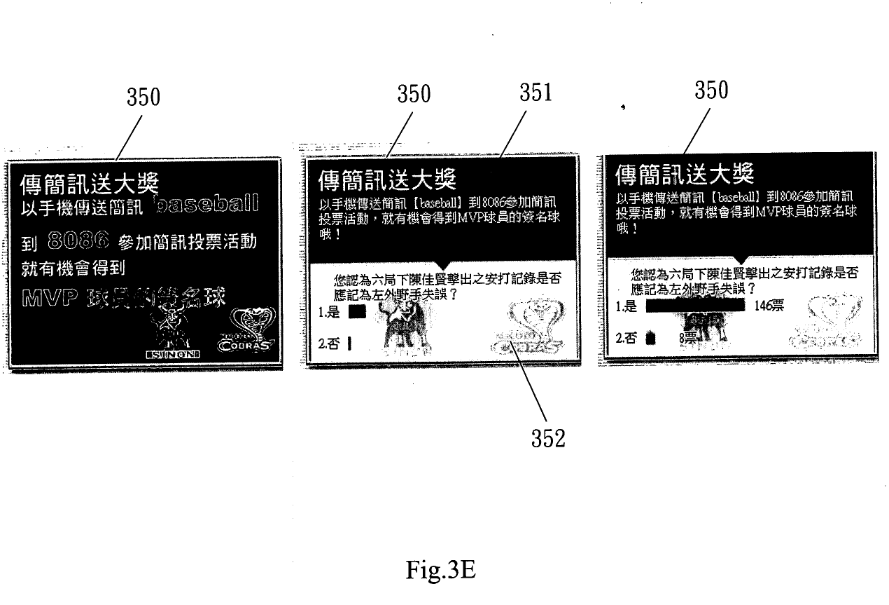

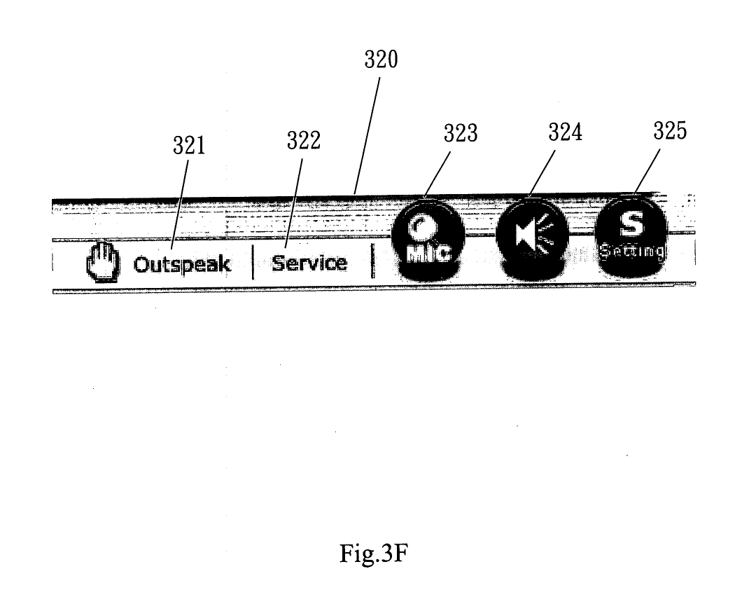

Refer to FIGS. 3A-3F, which are illustrations of an interactive multimedia interface and display according to an embodiment of the present invention.

As shown in the Figures, the interactive multimedia interface 300 comprises a multimedia window 310, a command bar 320, an information window 330, a chat room area 340, and a voting area 350.

As an example of an application of the interactive multimedia interface 300, FIG. 3A illustrates a baseball channel. The multimedia window 310 displays the live or pre-recorded action of the baseball game. Additionally, the multimedia window can be resized to full-screen for maximum viewing size as shown in FIG. 3B.

Statistics or other information is provided in the information window 330. As shown in FIG. 3C, the information in this example comprises the scoring, team statistics, or individual player statistics. Display selection buttons 331 allow the user to easily select which view they want. Additionally, each element in the information can be scrolled through or clicked to select.

As shown in FIG. 3D, the chat room area 340 allows members to communicate via text messages. A member can type their message into the text input box 341. When they are finished composing their message they press the send button 342 and the message will be displayed in the message window 344 of the chat room 340. The contents of the message window 344 can be scrolled through utilizing the scroll bar 343.

The voting area 350 allows the content provider or producer to ask questions or set up polls for members to vote. As shown in FIG. 3E, a question is displayed in the question area 351 of the voting area 350. The results are displayed in the results area 352. The results can be continuously updated until the final results are displayed.

Various commands can be selected on the command bar 320 as shown in FIG. 3F. The types of commands can be selected as required, but in this example the commands are speak 321, service 322, microphone 323, speaker 324, and settings 325. The speak button 321 allows members to speak into a microphone for other members to hear their comments. If a member needs service or assistance they can press the service button 322 and a representative or host can contact the member directly. The member's microphone and speakers can be setup by pressing the microphone 323 and speaker 324 buttons respectively. The setting button 325 allows the member to setup various other options.

The interactive multimedia interface and display of the present invention is very flexible and powerful. A number of tools and applications are provided. Content providers can decide which tools and applications are appropriate for their interactive multimedia content or program.

In the embodiment illustrated in FIG. 3A, the application is a baseball game. In that embodiment, the interface utilized an information window, command bar, voting window, chat room, and a multimedia window. However, in other embodiments, the interface comprises various other configurations and applications.

The interactive multimedia interface and display of the present invention comprises a number of programs, applications, tools, and windows that provide various interactions such as messaging, application sharing, synchronized internet browsing, file distribution and sharing, voting and polling, session recording, shared whiteboard, and chat room.

The present invention allows application sharing between users by providing an application sharing window. All Microsoft Windows programs can be shared between the host and users. For example, a host can execute and utilize a program while other users observe the actions, progress, and results. This is highly effective in demonstrating or training sessions where a host can teach or instruct a plurality of users at one time without being constrained to a single location.

Additionally, the host is able to pass application control to other users, which enables seamless communication and achieves real-time information exchange. For example, once the host has demonstrated a technique, the host can pass control to a user, student, or trainee and have them reproduce the actions or result. Furthermore, this allows users to utilize the program without requiring the application to be installed on the user's device or computer. This is useful for demonstrating products to potential buyers before they make a purchase.

The system also provides a synchronized Internet browser for allowing synchronization control over an Internet or network browser. The host can issue a link command and all users participating in the channel or session can browse through a webpage or website in sync.

For example, a marketing representative could introduce a variety of products displayed on the representative's company website to a number of prospective customers. Since the representative and the users are all synchronized they will be looking at the same items at the same time. Additionally, since users are able to interact, the users can ask questions via text or audio and the representative can answer via text or audio.

Also, this control can be passed to a user so that they can select a web site for all users to visit. In this way the synchronized browser can act as a tour guide and lead other users on a virtual tour of a website or the Internet all while allowing users to interact with each other.

File distribution is provided by a file distributor so that the host and users can deliver or exchange materials, multimedia, data, or files with participants in the channel or session. Individual users all have the right to accept or deny delivery of the exchanged data. The system can also emulate a pier to pier network in which users can share files or data between each other. In addition, users can communicate and interact with other users in order to recommend or discuss the files or data.

A voting or polling area is provided so that the host or users can create a poll and the participants can vote. The poll can be created manually or automatically from a questionnaire of file. Once voting begins, the system can provide the results to only the host or show the results to everyone. Additionally, the results can be updated and displayed in real time during the voting, or can be tallied and displayed after voting is over.

Also, this voting area can be used as a question and answer system. For example, on an educational channel the host or instructor can pose a question and each user or student can respond with their answer. The answers can be formulated in multiple choice, essay, fill in the blank, etc. formats. The percentage or number of users selecting each answer can be displayed during the answering or after everyone has answered. The user names of the participants selecting the correct response can also be displayed if desired.

Additionally, the voting or answer history can be kept for individual participants. For example, a series of questions can be posed as a test by the instructor and the test results for individual users can be obtained. Similarly in a voting application, the voting history or behaviour can be recorded for future application or review.

The present invention also provides a shared whiteboard for allowing users and hosts to draw, write, and paste pictures on a whiteboard. Multiple users can interact on the white board at the same time. The host has the privilege to allow or deny permission to use the white board to certain users on a group or individual basis.

The shared whiteboard allows a group of users to quickly interact and exchange ideas or brainstorm. For example, a number of employees in a corporation can view a proposed design and each person can make revisions or changes to the drawing and all participants will see this in real time.

A chat room area is provided for allowing users to use a chat room or chat area to communicate with other online users. The chat area can be a separate tabbed page or can be displayed on the same page as other interactive tools. The chat area can be separated into different areas or can be arranged as a single area for a channel. For example, on an educational channel for engineering, the chat area can be regarding all engineering or split into areas depending on discipline, i.e. mechanical, electrical, civil, etc.

Similar to the other interactive tools, the right to use the chat area can be selectively given or denied to individual users or groups of users. For example, if a particular user is being disruptive, their right to use the chat area can be revoked or suspended temporarily, permanently, or indefinitely.

A messaging area is provided for allowing users to communicate directly with a particular user without all other users observing the communication. For example, user A and user B can send text messages back and forth to each other without the other users being aware of or privilege to their conversation. However, the host has the ability to monitor the messaging if desired.

It should be noted that the chat room area and messaging area can be the same area or separate areas.

The present invention also provides a recorder. If given the privilege by the host, users can record the progress of a channel or meeting. Not only is the video recorded, but also information exchanged in chat room areas, messaging, voting, synchronized browsing, and whiteboard can be recorded. The host also has the ability to fully record the interaction or selectively record sections of the session. Once recorded, the user or host has the ability to replay the entire interaction at a later date. This is particularly useful for types of interactions such as meetings, conferences, lectures, training, etc.

For commercial content producers or providers an advertising area or window is provided. Content producers or providers can periodically or continuously display advertising or notices. The revenue earned by this advertising can be used to offset the cost of producing the interactive multimedia content.

Additionally, the voting area and advertising area can work together so that users can vote in regards to the advertised product or products. Alternatively, advertisements can be selected based on voting results. For example, if a poll asks for a user's favorite hobby and the user votes for sports, an advertisement regarding sports can be displayed.

To assist users in remembering times or schedules of live or pre-recorded content, a scheduler is provided. The scheduler allows users to establish a recording schedule for future sessions or occurrences. For example, if a live concert will be broadcast at a certain time or date, the user can enter the information in the scheduler and the concert will be recorded regardless if the user is present at the broadcast time.

Additionally, the scheduler can act as a timer or alarm which will give the user a notice or reminder when a session is approaching. For example, if a network meeting session will occur on a certain date, the scheduler will give the user notices at selected intervals to prepare the user for the session.

Digital Rights Management is provided in order to protect the multimedia content. If content producers desire to protect their content against copying or recording, the content can be encrypted or protected. In this way, users can view the content a single time, or only in real time, or are unable to record the multimedia stream. Additionally, the digital rights can prevent unauthorized users from viewing the content or allow users to pay for the rights to view or save the content.

A purchase area allows users to quickly and easily purchase multimedia content or products presented on a channel. For example, a user can purchase a movie or concert video while watching or after watching the content. Similarly, products shown, introduced, or advertised on a channel can easily be purchased by the user. If desired, the purchasing history or behaviour of individual or groups of users can be obtained. Users are able to enable or disable this function. A beneficial aspect to this function is that users can receive recommendations of like-minded users based on their purchasing history or pattern. For example, if user A purchases a Jazz music CD by artist B, the purchasing history of other users that also purchased artist B's CD can be used to recommend a similar artist C to user A.

The interface of the present invention displays the interactive tools, session, channel, and other interface options such as menus. The interface can be displayed in one page or comprise a multi-paged tabbed interface. Pages on the interface can be easily switched between by selecting the desired tab. This also works for creating a new page, for example, a clean whiteboard. The tabbed interface can also be synchronized or locked so that users see the same page. This control can be set or unlocked by the host for other users or by individual users for themselves.

Content providers or producers can establish the layout of the interface or users can set up the layout themselves. Typically, producers will create the layout of the interface in order to produce a distinctive or useful layout. A default layout is provided for a standard interface.

A channel guide is provided for displaying a program or channel guide to allow users to select between channels, obtain channel information, scheduling, etc. The channel guide works together with the scheduler module so that users can easily schedule recording or notification of upcoming events. The channel guide can group and display channels by multimedia type, content, area, location, interest, popularity, date, etc. In this way, users can, for example, quickly find content in their area of interest or shortly upcoming events.

The present invention also provides a bulletin window to allow hosts to send broadcast notices to users. The announcements or text can be scrolled horizontally, vertically, static, or displayed in other ways. This allows a host to send messages, for example, announcements, updates, or notices to all users or selected users. For example, on a sports channel, continuously updated scores can be displayed.

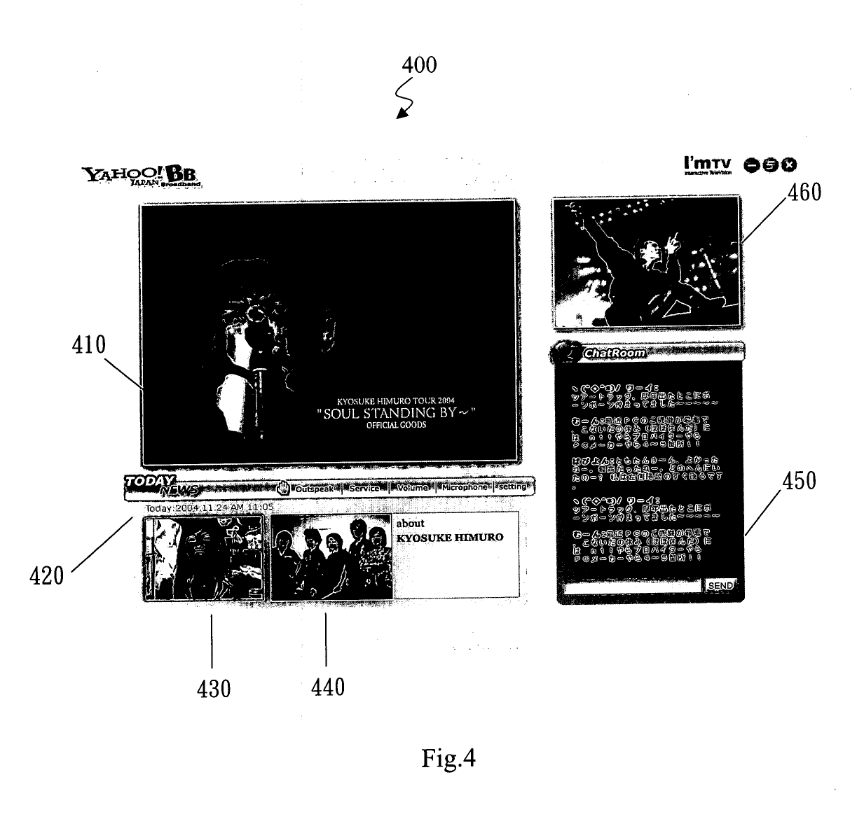

Refer to FIG. 4, which illustrates an interactive multimedia interface and display according to an embodiment of the present invention. In this embodiment, a live concert is given as an example of application.

As shown in FIG. 4, the interactive multimedia interface 400 comprises a first multimedia window 410, a second multimedia window 460, a command bar 420, a third multimedia window 430, an information window 440, and a chat room area 450.

In this example, video of the live concert is currently being displayed in the second multimedia window 460. The artist's latest album cover and other artwork or photos are displayed in the first multimedia window 410. The contents displayed in either the first multimedia window 410 or second multimedia window 460 can be switched between the windows. The third multimedia window 430 displays a host or other member's video. The information window 440 displays information about the artist. Members can text message or chat with other members and the host while the concert is in progress via the chat room area 450. Various commands and setup options can be selected on the command bar 420.

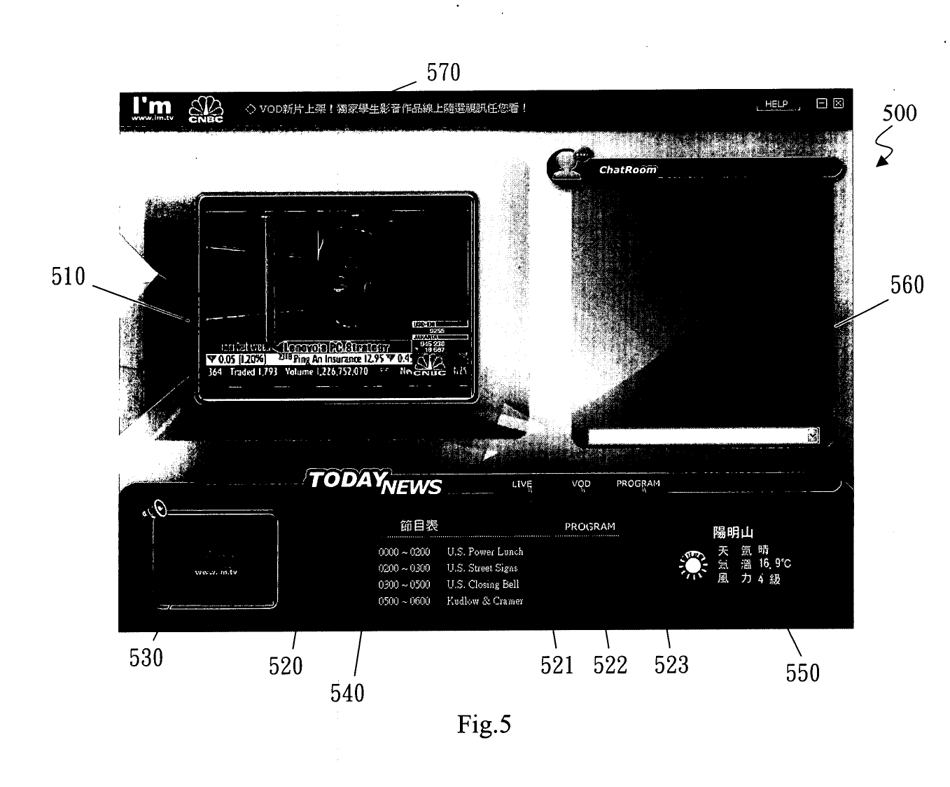

Refer to FIG. 5, which is an interactive multimedia interface and display according to an embodiment of the present invention.

As an example of a news application, the interactive multimedia interface 500 shown in FIG. 5 comprises a first multimedia window 510, a command bar 520, a second multimedia window, a program guide 540, an information window 550, and a chat room area 560.

In this example, traditional television news can be displayed in the first multimedia window 510. Information such as weather information is displayed in the information window 550. A host's or other member's video or additional multimedia content can be displayed in the second multimedia window 530. For example, a second presenter or video relative to the content displayed in the first multimedia window 510 can be shown in the second multimedia window 530. Members can discuss the topics or content in the chat room area 560 in real time with the other multimedia content.

The command bar 520 comprises buttons such as live 521, video on demand (VOD) 522, and program 523. The program guide 540 displays various program information and schedules. By selecting one of the live 521, VOD 522, or program 523 buttons, the program guide will display appropriate information and scheduling for that type of content.

Additional information can be sent to all members and displayed in the bulletin area 570.

As discussed above, the interactive multimedia interface and display of the present invention is extremely flexible and adaptable. In some applications, a simplified interface is desired.

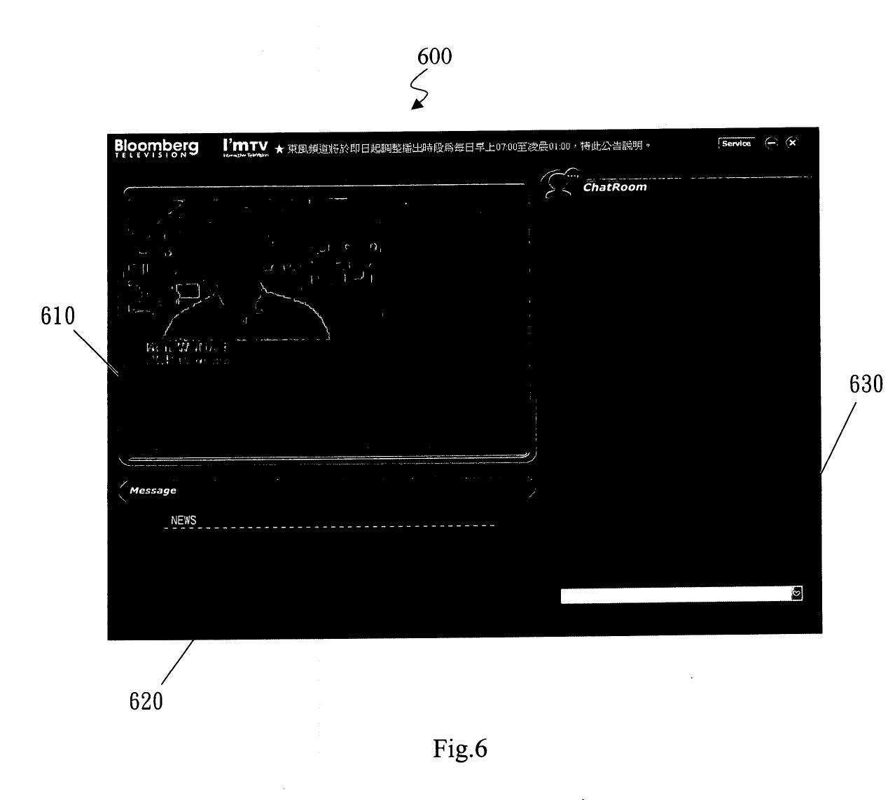

Refer to FIG. 6, which is an interactive multimedia interface and display according to the present invention. In this example, the multimedia interface 600 comprises a multimedia window 610, an information area 620, and a chat room area 630. This allows producers to provide a more simplified interface 600 for members.

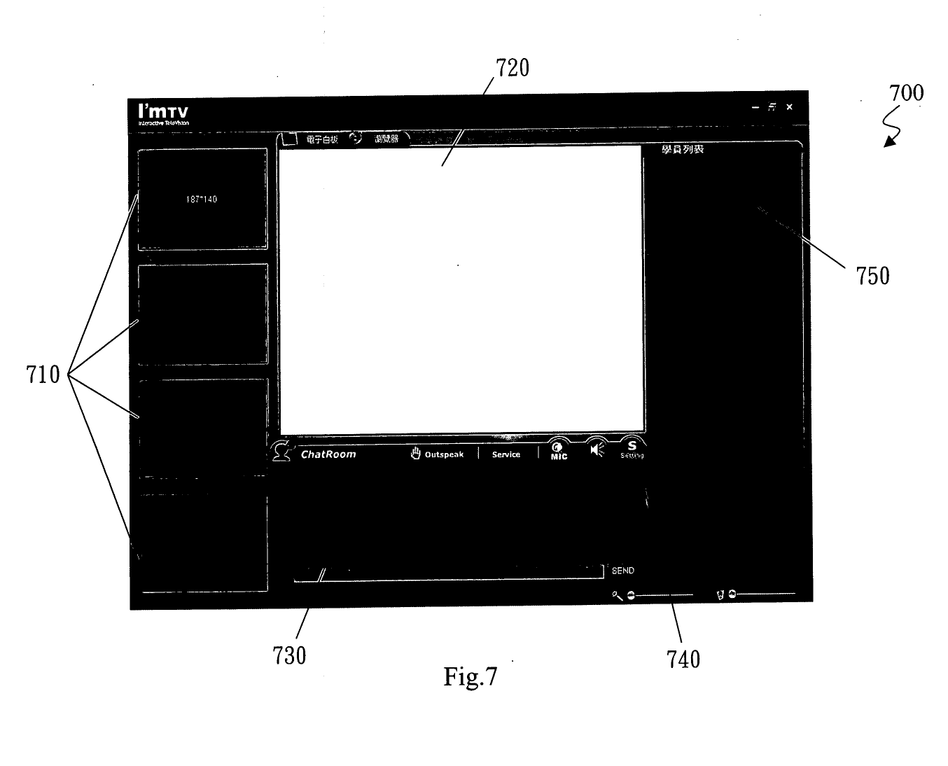

In other applications, more interactivity between members or users is desired. Refer to FIG. 7, which is an interactive multimedia interface and display according to an embodiment of the present invention. This application of the interface 700 is, for example, a group discussion. The interactive multimedia interface 700 comprises a plurality of multimedia windows 710, a shared whiteboard 720, a chat room area 730, a command bar 740, and a member list 750.

In this example, video of various members is displayed in the multimedia windows 710. All members can participate in utilizing the shared whiteboard 720 to exchange ideas. The members can also communicate with each other via audio signals or the chat room area 730.

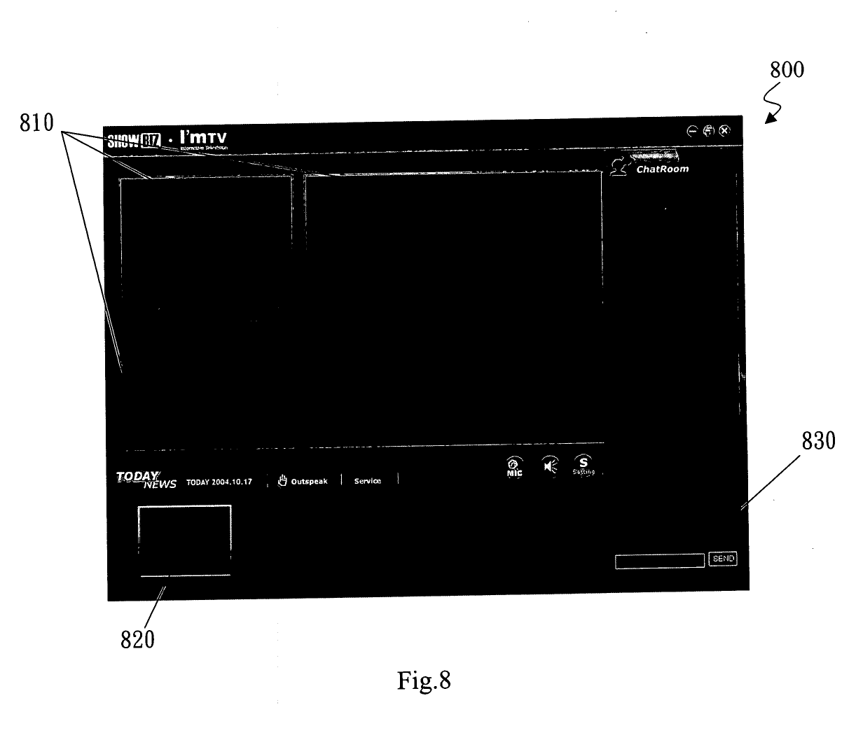

Referring to FIG. 8, the interactive multimedia interface 800 can comprise a plurality of multimedia windows 810, a chat room area, and an advertising area 820. Appropriate advertising can be displayed in the advertising area 820 while multimedia content is being streamed to the multimedia windows 810.

Obviously, many variations can be made to the above example. For example, the content, layout, applications, window size, number of users, providers, content location, etc. can be changed or adapted according to requirements.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An interactive multimedia interface and display comprising:
a plurality of multimedia content windows;
an interactive guide for assisting users in selecting multimedia content;
a file distributor for providing file and data sharing between users;
an application sharer for providing application sharing between users;
a synchronized network browser for allowing users to browse a network together;
a voting area for allowing users to vote;
a shared whiteboard on which users can draw, type, or paste images;
a chat room for allowing users to communicate with other users;
a recorder for allowing users to record content of the session;
a multi-paged tabbed interface for allowing users to switch between pages of the session; and
an advertising area for providing promotional material to users;

2. The interactive multimedia interface and display of claim 1, wherein the multimedia content comprises movies, videos, audio, music, games, presentations, or a combination of these.

3. The interactive multimedia interface and display of claim 1, wherein the multimedia content is streamed in real time or near real time.

4. The interactive multimedia interface and display of claim 1, wherein a plurality of multimedia is streamed in one signal.

5. The interactive multimedia interface and display of claim 1, wherein users can accept or refuse delivery of the shared file or data.

6. The interactive multimedia interface and display of claim 1, wherein the voting results are automatically tallied.

7. The interactive multimedia interface and display of claim 1, wherein the voting results are selectively shared with users.

8. The interactive multimedia interface and display of claim 1, wherein the users communicate in the chat room via text messages.

9. The interactive multimedia interface and display of claim 1, wherein right of individual users to utilize the whiteboard, chat room, or voting is selectively given or denied.

10. An interactive multimedia interface and display comprising:
an application sharer for allowing application sharing between users;
a synchronized browser for allowing synchronization control over an Internet browser;
a file distributor for allowing users to deliver or exchange materials, multimedia, data, or files with other users;
a voting area for allowing users to create a poll and vote;
a shared whiteboard for allowing users to draw, write, and paste pictures on a shared whiteboard;
a chat room area for allowing users to use a chat room to communicate with other online users
a messaging area for allowing users to privately communicate with other users;
a recorder module for allowing users to record content;
a channel guide for displaying an interactive guide to allow users to select between the multimedia content; and
an information area for displaying information to users.

11. The interactive multimedia interface and display of claim 10, further comprising:
an advertising area for allowing advertising to be displayed;
a scheduler for assisting users in scheduling;
a digital rights manager for protecting the multimedia content;
a purchasing area for allowing users to purchase the multimedia content or products presented;
a bulletin area for allowing hosts to send broadcast notices to users; and
a command bar for providing various settings and applications for users.

12. The interactive multimedia interface and display of claim 10, wherein the multimedia content is streamed in real time or near real time.

13. An interactive multimedia interface and display comprising:
an application sharer for allowing application sharing between users;
a synchronized browser for allowing synchronization control over an Internet browser;
a file distributor for allowing users to deliver or exchange materials, multimedia, data, or files with other users;
a voting area for allowing users to create a poll and vote;
a shared whiteboard for allowing users to draw, write, and paste pictures on a shared whiteboard;
a chat room area for allowing users to use a chat room to communicate with other online users
a messaging area for allowing users to privately communicate with other users;
a recorder for allowing users to record content;
an advertising area for allowing advertising to be periodically or continuously displayed;
a scheduler for assisting users in remembering times or schedules of live or pre-recorded content;
a digital rights manager for protecting the multimedia content;
a purchasing area for allowing users to purchase the multimedia content or products presented;
a channel guide for displaying an interactive guide to allow users to select between the multimedia content; and
a bulletin area for allowing hosts to send broadcast notices to users.

14. The interactive multimedia interface and display of claim 13, wherein the multimedia content comprises movies, videos, audio, music, games, presentations, or a combination of these.

15. The interactive multimedia interface and display of claim 13, wherein the multimedia content is streamed in real time or near real time.

16. The interactive multimedia interface and display of claim 13, wherein a plurality of multimedia is streamed in one signal.

17. The interactive multimedia interface and display of claim 13, wherein users can accept or refuse delivery of the shared file or data.

18. The interactive multimedia interface and display of claim 13, wherein voting results are automatically tallied.

19. The interactive multimedia interface and display of claim 13, wherein the users communicate in the chat room via text messages.

20. The interactive multimedia interface and display of claim 13, wherein right of individual users to utilize the whiteboard, chat room, or voting is selectively given or denied.
